(19) United States
(12) Patent Application Publication
(10) Pub. No.: US 2019/0320082 A1
(43) Pub. Date: Oct. 17, 2019

(54) IMAGE PROCESSING APPARATUS, IMAGE PROCESSING SYSTEM

(71) Applicant: KYOCERA Document Solutions Inc., Osaka (JP)

(72) Inventor: Hirotaka Sasaguri, Osaka (JP)

(21) Appl. No.: 16/378,952

(22) Filed: Apr. 9, 2019

(30) Foreign Application Priority Data
Apr. 11, 2018 (JP) 2018-075999

(51) Int. Cl. H04N 1/32; H04N 1/00

(52) U.S. Cl. CPC H04N 1/32069; H04N 1/00214; H04N 2201/0055; H04N 1/00408; H04N 2201/0094; H04N 1/00307

(57) ABSTRACT

An image processing apparatus is capable of transmitting acquired image data to one or more other apparatuses in a plurality of different formats, and includes a short-range communication portion configured to perform a short-range wireless communication with a mobile terminal, and a control portion configured to acquire contact destination information indicating one or more contact destinations registered in the mobile terminal, from the mobile terminal by the short-range wireless communication, recognize a transmission format for transmitting image data for each of the contact destinations, and transmit the image data to each of the contact destinations in the transmission format for each of the contact destinations.

### INCORPORATION BY REFERENCE

This application is based upon and claims the benefit of priority from the corresponding Japanese Patent Application No. 2018-075999 filed on Apr. 11, 2018, the entire contents of which are incorporated herein by reference.

### BACKGROUND

The present disclosure relates to an image processing apparatus that can be used in combination with a mobile terminal, and to an image processing system in which the image processing apparatus is used in combination with a mobile terminal.

As an image forming apparatus having a print function to form an image on a medium such as a sheet of paper, there is known a multifunction peripheral (MFP). The multifunction peripheral has various functions other than the print function, such as a scanner function to read an image from a document sheet, and a facsimile function to transmit image data by facsimile. To exert these functions at the maximum, the multifunction peripheral may be configured to communicate via a network, and exchange image data with a personal computer, another multifunction peripheral, and a mobile terminal (a smartphone or the like) that are connected to the network. This allows, for example, the multifunction peripheral to acquire image data from the mobile terminal, and transmit the image data by facsimile.

For example, there is known a multifunction peripheral that acquires, via a network, not only image data but also an address book managed by a mobile terminal, and uses the address book to identify a transmission destination of the image data. By using such a function, it is possible to cause the multifunction peripheral to function efficiently in combination with the mobile terminal.

### SUMMARY

An image processing apparatus according to an aspect of the present disclosure is capable of transmitting acquired image data to one or more other apparatuses in a plurality of different formats, and includes a short-range communication portion configured to perform a short-range wireless communication with a mobile terminal, and a control portion configured to acquire contact destination information indicating one or more contact destinations registered in the mobile terminal, from the mobile terminal by the short-range wireless communication, recognize a transmission format for transmitting image data for each of the contact destinations, and transmit the image data to each of the contact destinations in the transmission format for each of the contact destinations.

An image processing system according to another aspect of the present disclosure includes the image processing apparatus and the mobile terminal configured to transmit the contact destination information to the image processing apparatus by the short-range wireless communication.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image processing apparatus according to an embodiment of the present disclosure.

FIG. 2 is a block diagram showing a configuration of a mobile terminal used in an image processing system according to the embodiment of the present disclosure.

FIG. 3 shows an example of a contact destination list indicating contact destination information used in the image processing system according to the embodiment of the present disclosure.

FIG. 4 shows an example of a list of recognized image processing apparatuses displayed on the mobile terminal in the image processing system according to the embodiment of the present disclosure.

FIG. 5 shows an example of a list (option list) of contact destinations displayed on the image processing apparatus according to the embodiment of the present disclosure.

FIG. 6A to FIG. 6C show examples of screens for specifying transmission destinations among displayed contact destinations in the image processing apparatus according to the embodiment of the present disclosure.

FIG. 7 shows an example of a screen indicating image data transmission state, displayed on the image processing apparatus or the mobile terminal in the image processing system according to the embodiment of the present disclosure.

### DETAILED DESCRIPTION

The following describes an embodiment of the present disclosure with reference to the accompanying drawings. An image processing apparatus according to the present embodiment is used in combination with a mobile terminal in an image processing system. The image processing apparatus and the mobile terminal are connected to each other by a short-range wireless communication (Bluetooth®, Wi-Fi Direct® or the like). Specifically, the image processing apparatus is a multifunction peripheral having a plurality of functions such as a print function, a scanner function, and a facsimile function. The print function allows the apparatus to form an image on a medium (a sheet of paper or the like) and output the medium with the image formed thereon. The scanner function allows the apparatus to optically read an image from a document sheet and acquire image data of the read image. The facsimile function allows the apparatus to transmit and receive image data via a communication line (a telephone line or the like).

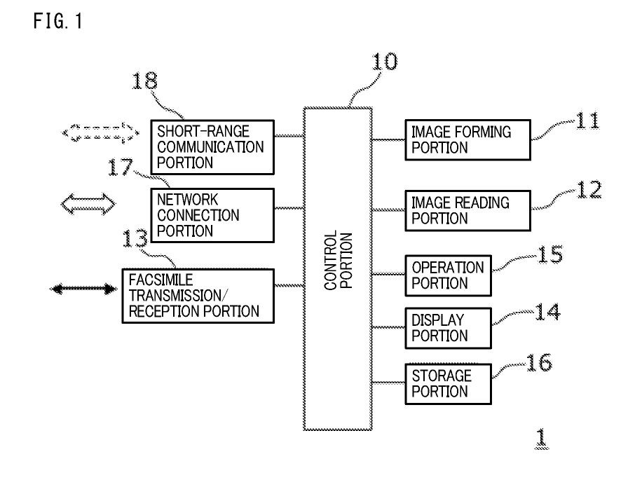

FIG. 1 is a schematic diagram showing a configuration of an image processing apparatus 1 highlighting its functions. As shown in FIG. 1, the image processing apparatus 1 includes an image forming portion 11, an image reading portion 12 (an example of an image reading portion of the present disclosure), and a facsimile transmission/reception portion 13. The image forming portion 11 is configured to execute the print function based on image data or print data. The image reading portion 12 is configured to execute the scanner function to optically read an image from a document sheet and acquire image data of the read image. The facsimile transmission/reception portion 13 is configured to execute the facsimile function to transmit, via a communication line, image data obtained from the image reading portion 12 or the like, or to receive image data from external facsimile apparatuses via a communication line (a telephone line).

For the above-described functions to be executed, the image processing apparatus 1 includes a control portion (apparatus-side control portion) 10 that includes a CPU for controlling various components of the apparatus. The control portion 10 is an example of a control portion of the present disclosure. Information necessary for executing the functions is displayed on a display portion 14 (an example of a display portion of the present disclosure), and the user performs an operation on an operation portion 15 to instruct execution of a function. The display portion 14 and the operation portion 15 may be integrally provided as a touch panel display. Various types of data (including image data) that are used during execution of the functions are stored in a storage portion 16 that includes a hard disk or a semiconductor memory.

In the image processing apparatus 1, for example, the image forming portion 11 performs a print output based on a print job transmitted from a personal computer connected with the image processing apparatus 1 via a network. The image processing apparatus 1 may transmit and receive various types of data to/from the personal computer. The image processing apparatus 1 includes a network connection portion 17 that is an interface for connecting to a network such as the Internet. In addition, the facsimile transmission/reception portion 13 connects to another communication line (telephone line) to execute the facsimile function. Accordingly, a telephone number is set in the image processing apparatus 1, the telephone number serving as an identification number of the image processing apparatus 1 as a facsimile transmission/reception apparatus.

The image processing apparatus 1 is capable of transmitting, for example, image data acquired by the image reading portion 12 to external apparatuses. Specifically, the image data can be transmitted by the facsimile function via the facsimile transmission/reception portion 13, or transmitted via the network connection portion 17. The image processing apparatus 1 can transmit the image data via the network connection portion 17 by: transmitting an e-mail to which an image file including the image data is attached; or storing an image file including the image data directly in a shared folder of a transmission-destination server or personal computer by SMB (Server Message Block).

The image processing apparatus 1 includes a short-range communication portion 18 (an example of a short-range communication portion of the present disclosure) that is an interface for performing the short-range wireless communication (Bluetooth®, Wi-Fi Direct® or the like). The image processing apparatus 1 is generally large and is fixed to a building. The image processing apparatus 1 is connected by the short-range wireless communication to an apparatus that is within a distance that allows the apparatus to perform the short-range communication with the image processing apparatus 1. The apparatus is generally a mobile terminal (a smartphone or the like) carried by the user.

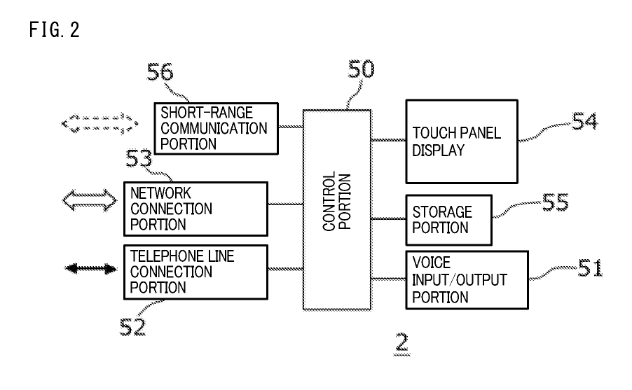

FIG. 2, like FIG. 1, is a schematic diagram showing a configuration of a mobile terminal 2 that is used in combination with the image processing apparatus 1. That is, an image processing system according to the present disclosure is composed of the image processing apparatus 1 and the mobile terminal 2. The mobile terminal 2 has a voice communication function for performing a voice communication with another mobile terminal via a communication line. The mobile terminal 2 also has, like a personal computer, functions that use a network, such as a content viewing function for viewing a content acquired via the network on a touch panel display. The mobile terminal 2 operates on a dedicated OS (Operating System).

To support the functions, the mobile terminal 2 includes a voice input/output portion 51. The voice input/output portion 51 is configured to input and output electric signals converted from voices for the voice communication function. The mobile terminal 2 exchanges the electric signals with external apparatuses via a telephone line connection portion 52. In addition, as is the case with the image processing apparatus 1, the mobile terminal 2 transmits image data to external facsimile apparatuses by facsimile via the telephone line connection portion 52.

The mobile terminal 2 includes a network connection portion (terminal-side network connection portion) 53 for performing the functions using the network. As is the case with the image processing apparatus 1, the mobile terminal 2 can transmit the image data via the network connection portion 53 by: transmitting an e-mail to which an image file including the image data is attached; or storing an image file including the image data directly in a shared folder of a transmission-destination server or personal computer by SMB.

In the mobile terminal 2, mainly, the user operates a touch panel display (terminal-side display portion) 54 to execute the above-described functions. Information necessary for performing the operation is displayed on the touch panel display 54. The mobile terminal 2 includes a control portion (terminal-side control portion) 50 that includes a CPU for controlling various components of the mobile terminal for the functions to be executed. Various types of data that are used during execution of the functions are stored in a storage portion (terminal-side storage portion) 55 that includes a semiconductor memory.

The mobile terminal 2 includes a short-range communication portion (terminal-side short-range communication portion) 56 (an example of the short-range communication portion of the present disclosure) that is an interface for performing the short-range wireless communication (Bluetooth®, Wi-Fi Direct® or the like) with the image processing apparatus 1.

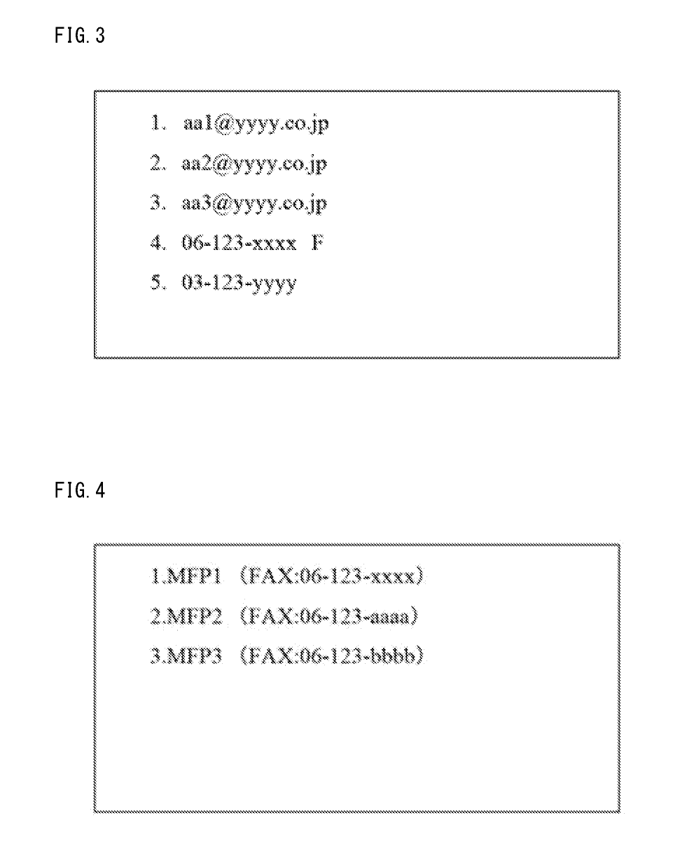

Here, in a case where the user uses the voice communication function, the facsimile transmission function, and the e-mail transmission/reception function of the mobile terminal 2, the user often registers destinations for these communications in advance. The registered destinations are stored in the storage portion 55 as contact destination information. FIG. 3 shows an example of a contact destination list that is made from the contact destination information. Here, the contact destinations No. 1 to No. 3 are e-mail addresses, and the contact destinations No. 4 to No. 5 are telephone numbers. It is noted that a telephone number can be used as both a telephone number and a facsimile number or used as a dedicated facsimile number. The sign “F” added to the last of the contact destination No. 4 indicates that the telephone number is recognized as a facsimile (FAX) number in the contact destination information. It is noted that although omitted in the drawing, other identification information (such as the name or the company name) is also stored in association with the contact destination information.

The control portion 50 is configured to display the contact destination list shown in FIG. 3 on the touch panel display 54 so that the user can select one from the contact destinations No. 1 to No. 5. When the user has selected any one of the contact destinations No. 1 to No. 3, the control portion 50 activates an application that displays an e-mail creation screen on the touch panel display 54 so that the user can create an e-mail to be transmitted to the selected contact destination. When the user has selected the contact destination No. 5, the control portion 50 activates an application that accesses the telephone number and executes the voice communication function by causing the voice input/output portion 51 to operate. In addition, when the user has selected the contact destination No. 4, the control portion 50 displays, on the touch panel display 54, a screen on which the user can select any of document files and image files stored in the storage portion 55, and transmits a selected image file to a facsimile apparatus of the FAX number via a telephone line so that the image file is printed and output from the facsimile apparatus. It is noted that according to the contact destination list shown in FIG. 3, only telephone numbers (facsimile numbers) and e-mail addresses are registered. However, contact destinations for the SMB transmission may be registered as well. In that case, server names of the transmission-destination servers (or IP addresses of the servers) and identification information of shared folders in which the transmitted data is to be stored, are registered in a similar manner. If authentication is necessary for the shared folders to be accessed, the authentication information is also registered.

As described above, the mobile terminal 2 provides the user with easy operation to execute the functions by allowing the user to use the contact destination information stored in the storage portion 55.

Conventionally, data of an address book was exchanged between the image processing apparatus 1 and the mobile terminal 2 via a network. In that case, from the view point of security, it was necessary to, for example, set a password for using the address book. This reduces a convenience that the image processing apparatus 1 can acquire the address book managed by the mobile terminal 2 and use it to identify transmission destinations of image data.

On the other hand, the image processing apparatus 1 according to the present embodiment acquires the contact destination information from the mobile terminal 2 by the short-range wireless communication and store it in the storage portion 16. Thereafter, the contact destination information can be used when image data is newly obtained in the image processing apparatus 1. The contact destination information can be transmitted from the mobile terminal 2 to the image processing apparatus 1 only when the image processing apparatus 1 is within a range in which the short-range wireless communication with the mobile terminal 2 is possible. In addition, when a plurality of image processing apparatuses exist within the range of the short-range wireless communication, the user can specify, on the mobile terminal 2, one of the plurality of image processing apparatuses for the contact destination information to be transmitted thereto from the mobile terminal 2. With this configuration, the contact destination information can be exchanged between the image processing apparatus 1 and the mobile terminal 2 without setting a password or the like, thereby preventing the contact destination information from being leaked against the user's intention.

For example, when three MFPs (MFP1, MFP2, and MFP3) exist within the range in which the short-range wireless communication with the mobile terminal 2 is possible, the control portion 50 recognizes the three MFPs via the short-range communication portion 56. The control portion 50 displays a list of the three MFPs (see FIG. 4) on the touch panel display 54. In this example, each MFP is identified by its FAX number that is displayed together with each MFP. However, not limited to this, another type of identification information (for example, the model name) may be displayed. The contact destination information is transmitted only to an MFP selected by the user on the screen of the touch panel display 54, and is not transmitted to the other MFPs.

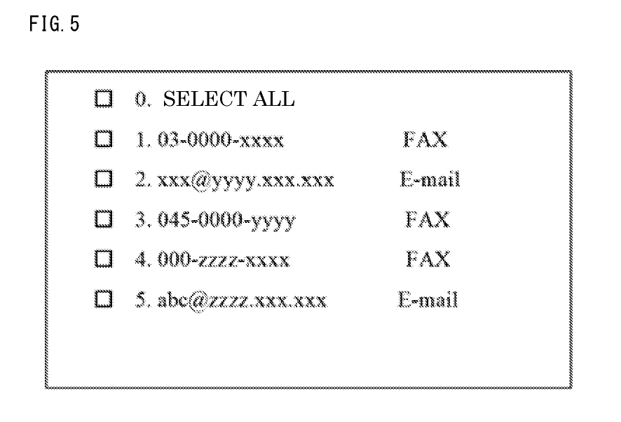

Next, an operation of the image processing apparatus 1 after receiving the contact destination information is described. The operation is performed when, for example, image data is newly acquired by the image reading portion 12. Upon recognizing that image data has been acquired newly, the control portion 10 generates an option list shown in FIG. 5 based on the contact destination information stored in the storage portion 16, and displays it on the display portion 14 so that the user can select transmission destination(s) of the image data from the list. Here, there may be a case where a plurality of sets of contact destination information are acquired from different mobile terminals 2 and stored in the storage portion 16. In that case, the option list is generated based on all of the plurality of sets of contact destination information, and overlapping contact destinations are displayed as one contact destination. In this example, options No. 1 to No. 5 for contact destinations are displayed for selection. The options No. 1, No. 3 and No. 4 are FAX numbers, and options No. 2 and No. 5 are e-mail addresses. The option No. 0 is for selecting all the options No. 1 to No. 5 for contact destinations.

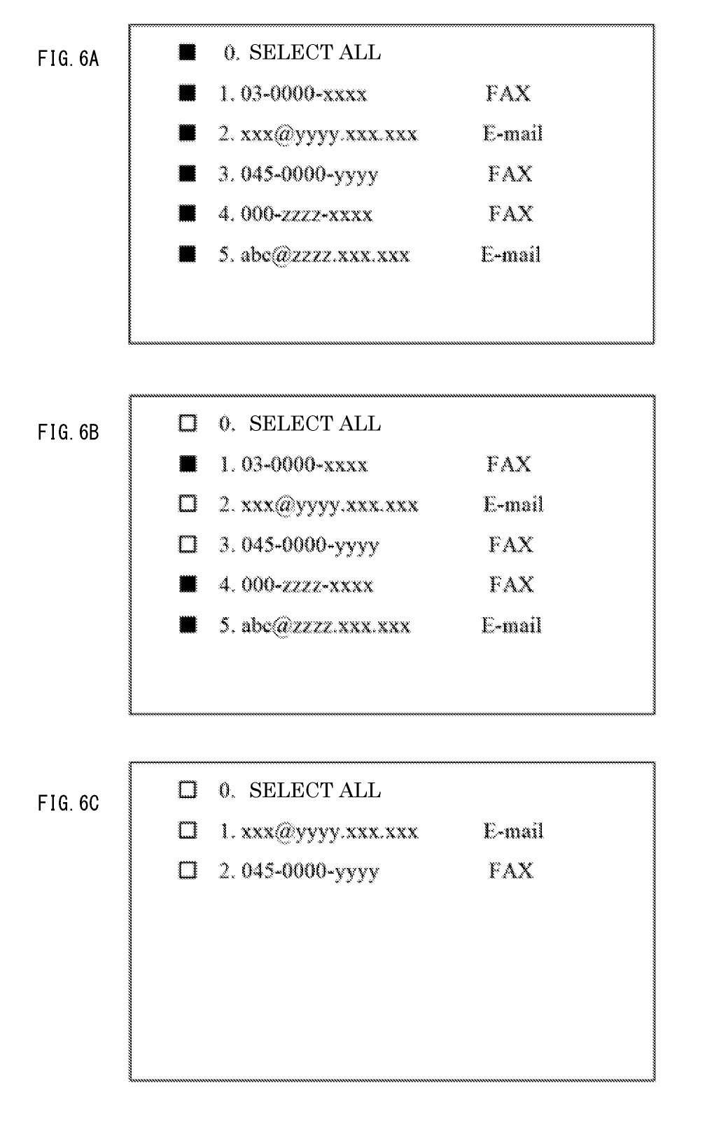

FIG. 6A shows how the selection list is displayed after the option No. 0 is selected. When the option No. 0 is selected, the image data is transmitted to all the contact destinations displayed. Specifically, the control portion 10 causes the facsimile transmission/reception portion 13 (the FAX number of the image processing apparatus 1) to transmit the newly acquired image data to the contact destinations corresponding to the options No. 1, No. 3, and No. 4 by facsimile. On the other hand, the control portion 10 transmits an e-mail to which an image file including the image data is attached, to the contact destinations corresponding to the options No. 2 and No. 5 via the network connection portion 17 from an e-mail address of the image processing apparatus 1.

FIG. 6B shows how the selection list is displayed after the options No. 1, No. 4, and No. 5 are selected. Selecting a part of the options is suitable for, for example, a case where different pieces of image data are to be transmitted to different contact destinations. When the options No. 1, No. 4, and No. 5 are selected, the control portion 10 transmits the image data (image file) to the contact destinations corresponding to the options No. 1 and No. 4 by facsimile, and transmits an e-mail to which an image file including the image data is attached, to the contact destination corresponding to the option No. 5.

After these transmissions are completed, the control portion 10 displays a list as shown in FIG. 6C on the display portion 14. In this list, the contact destinations (the options No. 2 and No. 3 in FIG. 5) which were not selected from the list shown in FIG. 6B and to which the image data has not been transmitted, are displayed as new options No. 1 and No. 2. In this state, when image data is newly acquired by the image reading portion 12 in accordance with a user's operation of the image processing apparatus 1, the user can transmit the newly acquired image data (image file) to the contact destinations corresponding to the new options No. 1 and No. 2 in the same manner as described above.

After image data is transmitted to all the contact destinations displayed in the list of FIG. 5, the control portion 10 displays, for example, a message “image data was transmitted to all the contact destinations”, without displaying the contact destinations as shown in FIG. 5 to FIG. 6C, and ends the job concerning transmission of image data.

In case no input is given in a predetermined time period while the option list shown in FIG. 5 is displayed, the control portion 10 determines that image data does not need to be transmitted. In this case, the control portion 10 preferably causes the display of contact destinations as shown in FIG. 5 to disappear from the display portion 14. This restricts unnecessary display of contact destinations and prevents them from being leaked to outside. In this case, the control portion 10 may delete or reset the contact destination information stored in the storage portion 16.

When the image processing apparatus 1 performs the above-described operation, the control portion 10 and the mobile terminal 2 exchange the contact destination information therebetween via the short-range communication portion 18. As a result, only a mobile terminal 2 that can perform the short-range wireless communication with the image processing apparatus 1 can exchange the contact destination information with the image processing apparatus 1. For example, in a case where Bluetooth® is adopted as the short-range wireless communication, a mobile terminal 2 can transmit the contact destination information only to an image processing apparatus 1 that is close enough to pair with the mobile terminal 2. With this configuration, a user who operates either of the image processing apparatus 1 and the mobile terminal 2 that communicate with each other, can recognize the other communication partner apparatus in a reliable manner, and the contact destination information is not exchanged with apparatuses that are not recognized by the user. In this way, the image processing system according to the present embodiment has high security capability in dealing with the contact destination information, without requiring, for example, password setting. This increases the convenience in using the mobile terminal 2 in combination with the image processing apparatus 1.

There may be a case where a registered facsimile number is not a number of a facsimile apparatus, but a number of a telephone apparatus, or a case where a registered facsimile number is a number of a telephone apparatus that also serves as a facsimile apparatus, and when an attempt is made to transmit image data thereto, the apparatus is in a state where it can function only as a telephone apparatus. In such cases, image data cannot be transmitted. As a result, if a transmission-destination facsimile apparatus does not become ready to receive a facsimile in a predetermined time period, the control portion 10 may stop the transmission and recognize it as a transmission failure. Similarly, in a case where an e-mail fails to be transmitted to a specified e-mail address, or a case where an apparatus with an IP address as the SMB transmission destination cannot be found, the control portion 10 recognizes it as a transmission failure.

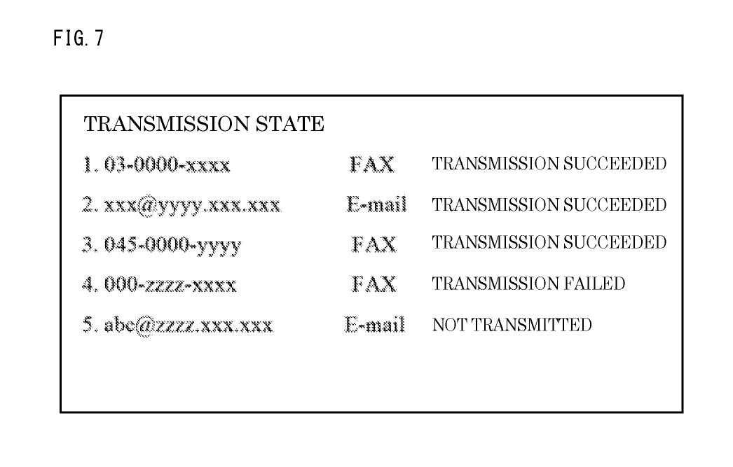

In view of the above-described cases, the control portion 10 is configured to display the current image data transmission state in a list format on the display portion 14 as shown in FIG. 7. In this example of the list, contact destinations No. 1 to No. 5 have been selected as the transmission destinations. The displayed list indicates that a facsimile transmission to the transmission destination No. 4 (facsimile apparatus) resulted in a failure since the transmission could not be done within the predetermined time period. In addition, in the displayed list, the transmission state of the transmission destination No. 5 is indicated as “NOT TRANSMITTED” meaning that the transmission is not completed yet.

The control portion 10 may not only display the list shown in FIG. 7 on the display portion 14 of its associated apparatus (the image processing apparatus 1) but also transmit data (transmission information) indicating the current transmission state of image data to the mobile terminal 2 by the short-range wireless communication. This allows the control portion 50 of the mobile terminal 2 to display the list shown in FIG. 7 on the touch panel display 54 in a similar manner. This allows the user to recognize the image data transmission state easily.

In addition, this allows the control portion 50 to reflect, for example, the transmission failure of a transmission to the transmission destination No. 4 in the list shown in FIG. 7, in the contact destination information stored in the mobile terminal 2 side. For example, after displaying the list shown in FIG. 7, the control portion 50 may store information that a latest transmission to the transmission destination No. 4 has failed, as additional information to the contact destination information. This will attract the user's attention when the user tries to access the contact destination next time. This also applies to a case where an e-mail transmission has failed. The additional information will attract the user's attention when the user tries to send an e-mail to the e-mail address next time.

By using the short-range wireless communication also in exchanging information of data transmission state, it is possible to prevent, for example, e-mail addresses from being leaked to outside.

The configuration of the image processing apparatus according to the present disclosure is not limited to the configuration shown in FIG. 1, but is arbitrary. Similarly, the configuration of the mobile terminal according to the present disclosure is not limited to the configuration shown in FIG. 2, but is arbitrary. That is, the above-described configurations are applicable to various image processing apparatuses and mobile terminals that have various functions. In addition, it is possible to configure a high-function image processing system by combining the image processing apparatus and the mobile terminal.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus for transmitting acquired image data to one or more other apparatuses in a plurality of different formats, the image processing apparatus comprising:
a short-range communication portion configured to perform a short-range wireless communication with a mobile terminal; and
a control portion configured to acquire contact destination information indicating one or more contact destinations registered in the mobile terminal, from the mobile terminal by the short-range wireless communication, recognize a transmission format for transmitting image data for each of the contact destinations, and transmit the image data to each of the contact destinations in the transmission format for each of the contact destinations.

2. The image processing apparatus according to claim 1, wherein
the control portion transmits the image data by facsimile via a communication line, by transmitting, via a network, an e-mail to which an image file including the image data is attached, or by SMB, and
the contact destination information includes any one of a facsimile number as a contact destination, an e-mail address as a contact destination, and identification information of a transmission destination for SMB transmission.

3. The image processing apparatus according to claim 1, wherein
the contact destination information includes a plurality of contact destinations,
the image processing apparatus further comprises:
a display portion configured to display the plurality of contact destinations, and
the control portion transmits the image data to one or more contact destinations selected by a user from the plurality of contact destinations displayed on the display portion.

4. The image processing apparatus according to claim 3, further comprising:
an image reading portion configured to acquire image data by optically reading a document sheet, and
the control portion displays the plurality of contact destinations on the display portion each time the image reading portion acquires image data.

5. The image processing apparatus according to claim 3, wherein
when an operation of selecting at least one contact destination from the plurality of contact destinations displayed on the display portion is not performed in a predetermined time period, the control portion causes display of the contact destinations to disappear from the display portion.

6. The image processing apparatus according to claim 1, wherein
the control portion transmits transmission information to the mobile terminal, the transmission information indicating a transmission state of the image data to the contact destinations.

7. An image processing system comprising:
the image processing apparatus according to claim 1; and
the mobile terminal configured to transmit the contact destination information to the image processing apparatus by the short-range wireless communication.

8. The image processing system according to claim 7, wherein
the image processing apparatus is one of a plurality of image processing apparatuses comprised in the image processing system, and
the mobile terminal does not transmit the contact destination information to one or more image processing apparatuses that have not been selected by a user from the plurality of image processing apparatuses.
